(19) United States
(12) Patent Application Publication
(10) Pub. No.: US 2010/0040968 A1
(43) Pub. Date: Feb. 18, 2010

(54) Toner Compositions Including Silica Blends

(76) Inventors: Ligia Aura Bejat, Versailles, KY (US); Rick Owen Jones, Berthoud, CO (US); Bryan Patrick Livengood, Nicholasville, KY (US); Kasturi Rangan Srinivasan, Longmont, CO (US); Devon Jean Vaccaro Strain, Shelbyville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/190,355

(22) Filed: Aug. 12, 2008

(51) Int. Cl. G03G 9/08; G03G 5/00

(52) U.S. Cl. 430/108.6; 430/108.7; 430/137.21

(57) ABSTRACT

A toner composition and method of providing such composition which may be used in a printer or printer cartridge. The composition may include toner particles mixed with silica particles having a primary particle size in the range of 30 nm to 60 nm present in the range of 0.1 to 2.0% by weight of the toner composition and silica particles having a primary particle size in the range of 60 nm to 150 nm present in the range of 0.1 to 2% by weight of the toner composition.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally toner formulations including silica blends utilizing relatively large and relatively medium size silica particles.

2. Description of the Related Art

Toner may be utilized in image forming devices, such as printers, copiers and/or fax machines to form images upon a sheet of media. The image forming apparatus may transfer the toner from a reservoir to the media via a developer system utilizing differential charges generated between the toner particles and the various components in the developer system. Control of toner tribocharge and flow properties may be achieved by dry toner surface modification and the attachment or placement of fine particles, or extra-particulate additives on the surface of the particles.

### SUMMARY OF THE INVENTION

An aspect of the present disclosure relates to a toner composition. The toner composition may include toner particles, silica particles combined with the toner particles having a primary particle size in the range of 30 nm to 60 nm and present in the range of 0.1 to 2.0% wt of the toner composition, and silica particles combined with the toner particles having a primary particle size in the range of 60 nm to 150 nm and present in the range of 0.1 to 2% by weight of the toner composition.

Another aspect of the present disclosure relates to a method of mixing toner particles with silica particles having a primary particle size in the range of 30 nm to 60 nm, present in the range of 0.1 to 2.0% wt of the toner composition, and silica particles having a primary particle size in the range of 60 nm to 150 nm, present in the range of 0.1 to 2% by weight of the toner composition.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The present disclosure is directed at a composition and method for improving the charge and charge stability of a toner composition by providing extra particular agents including relatively mid-size silica (SiO₂) and relatively large silica (SiO₂) to the toner, and in particular, to the toner particle surface. The toner particles may be prepared by a chemical process, such as suspension polymerization or emulsion aggregation. In one example, the toner particles may be prepared via an emulsion aggregation procedure, which generally provides resin, colorant and other additives. More specifically, the toner particles may be prepared via the steps of initially preparing a polymer latex from vinyl type monomers, such as acrylate based monomers or styrene-acrylate base copolymers, in the presence of an ionic type surfactant. The polymer latex so formed may be prepared at a desired molecular weight distribution (MWD=Mw/Mn) and may, e.g., contain both relatively low and relatively high molecular weight fractions to thereby provide a relatively bimodal distribution of molecular weights. It may therefore be appreciated that the toner particles herein may utilize polymeric resins wherein the Mw/Mn may be in the range of 15-25, including all values and increments therein. In addition, the polymeric resins herein may include those resins that have a glass transition temperature of 40-60 ° C. (as measured by DSC at a heating rate of about 10° C.min, where Tg is taken as the midpoint of the change in reported heat capacity versus temperature output). Pigments may then be milled in water along with a surfactant that has the same ionic charge as that employed for the polymer latex. Release agent (e.g. a wax or mixture of waxes) including olefin type waxes such as polyethylene may also be prepared in the presence of a surfactant that assumes the same ionic charge as the surfactant employed in the polymer latex. Optionally, one may include a charge control agent.

The polymer latex, pigment latex and wax latex may then be mixed and the pH adjusted to cause flocculation. For example, in the case of anionic surfactants, acid may be added to adjust pH to neutrality. Flocculation therefore may result in the formation of a gel where an aggregated mixture may be formed with particles of about 1-2 μm in size.

Such mixture may then be heated to cause a drop in viscosity and the gel may collapse and relative loose (larger) aggregates, from about 1-25 μm, may be formed, including all values and ranges therein. For example, the aggregates may have a particle size between 3 μm to about 15 μm, or between about 5 μm to about 10 μm. In addition, the process may be configured such that at least about 80-99% of the particles fall within such size ranges, including all values and increments therein. Base may then be added to increase the pH and reionize the surfactant or one may add additional anionic surfactants. The temperature may then be raised to bring about coalescence of the particles. Coalescence is reference to fusion of all components. The toner may then be removed from the solution, washed and dried.

It is also contemplated herein that the toner particles may be prepared by a number of other methods including mechanical methods, where a binder resin is provided, melted and combined with a release agent such as a wax, colorant and other optional additives. The product may then be solidified, ground and screened to provide toner particles of a given size or size range.

The resulting toner may have an average particle size in the range of 1 μm to 25 μm. The toner may then be treated with a blend of extra particulate agents, including relatively mid-size silica, relatively large silica, and optionally, alumina, relatively small silica, and/or titania. Treatment using the extra particulate agents may occur in one or more steps, wherein the given agents may be added in one or more steps.

Relatively mid-size silica may be understood as silica having a primary particle size in the range of 30 nm to 60 nm, or between 40 nm to 50 nm, prior to any after treatment, including all values and increments therein. Primary particle size may be understood as the largest linear dimension through a particle volume. The relatively mid-size silica may be present in the toner formulation as an extra particulate agent in the range of 0.1% to 2.0% by weight of the toner composition, including all values and increments in the range of 0.1% to 2.0% by weight. The mid-size silicas may also be treated with surface additives that may impart different hydrophobic characteristics or different charges to the silica. For example, the silica may be treated with hexamethyldisilazane, polydimethylsiloxane (silicone oil), etc. Exemplary silicas may be available from Evonik Degussa under the tradename AEROSIL and product numbers RX-50 or RY-50.

Relatively large silica may be understood as silica having a primary particle size in the range of 60 nm to 150 nm, or between 70 to 120 nm, prior to any after treatment, including all values and increments therein. The relatively large silica may be present in the toner formulation as an extra particulate agent in the range of 0.1 to 2 wt %, for example in the range of 0.25 wt % to 1 wt % of the toner composition. The large silicas may also be treated with surface additives that may impart different hydrophobic characteristics or different charges to the silica. For example, the silica may be treated with hexamethyldisilazane, polydimethylsiloxane, dimethyldichlorosilane, and combinations thereof, wherein the treatment may be present in the range of 1 wt % to 10 wt % of the silica.

In one example, the relatively mid-size silica may be treated with hexamethyldisilazane and the relatively large silica may be treated with polydimethylsiloxane and vice versa. In another example, the relatively mid-size silica may be treated with hexamethyldisilazane and the relatively large silica may be treated with hexamethyldisilazane. In a further example, the relatively mid-size silica may be treated with polydimethylsiloxane and the relatively large silica may be treated with polydimethylsiloxane.

The alumina (Al₂O₃) that may be used herein may have an average primary particle size in the range of 5 nm to 20 nm, including between 8 to 16 nm (largest cross-sectional linear dimension). In addition, the alumina may be surface treated with an inorganic/organic compound which may then improve mixing (e.g. compatibility) with organic based toner compositions. For example, the alumina may include an octylsilane coating. The alumina may be present in the range of 0.01% to 1.0% by weight of the toner composition, including all values and increments therein, such as in the range of 0.01% to 0.25%, or 0.05% to 0.10% by weight. An example of the aluminum oxide may be that available from Evonik Degussa under the tradename AEROXIDE and product number C 805.

Relatively small silica may be understood as silica (SiO₂) having an average primary particle size in the range of 2 nm to 20 nm, or between 5 nm to 15 nm (largest cross-sectional linear dimension) prior to any after treatment, including all values and increments therein. The relatively small silica may be present in the toner formulation as an extra particulate agent in the range of 0.1% to 0.5% by weight, including all values and increments therein. In addition, the relatively small silica may be treated with hexamethyldisilazane. An exemplary silica may be available from Evonik Degussa under the tradename AEROSIL and product numbers R812.

In addition, titania (titanium-oxygen compounds such as titanium dioxide) may be added to the toner composition as a extra particulate additive. The titania may be present in the formulation in the range of about 0.2% to 1.0% by weight, including all values and increments therein. The titania may include a surface treatment, such as aluminum oxide. The titania particles may have a mean particle length in the range of 1.0 μm to 3.0 μm, such as 1.68 μm and a mean particle diameter in the range of 0.05 μm to 0.2 μm, such as 0.13 μm. An example of titania contemplated herein may include FTL-110 available from ISK USA.

A method of formulating a toner composition may include combing the toner particles with the relatively mid-size silica and the relatively large size silica. For example, a relatively small silica and alumina may be combined with the toner particles in a first step and in a second step the relatively mid-size silica and relatively large silica, as well as the titania, if present, may be combined with the toner particles. The additives may be combined in a high shear blender, such as a Cyclomix, available from Hosokawa Micron, LTD or a high intensity Henschel Mixer available from Reimelt Henschel Misch Systems.

### EXAMPLES

The examples herein are meant for illustrative purposes only and are not meant to limit the disclosure herein.

Various silica particles were utilized in the Examples herein, wherein the particles may incorporate various surface treatments. Table 1 outlines these particles, their respective average particle size prior to surface treatment and their surface treatments.

TABLE 1

| | | |
|---|---|---|
| Extra Particulate | | |
| Additive | Particle Size | Surface Treatment |

Relatively Small Silica

| | | |
|---|---|---|
| AEROSIL R812 | 8 nm | Hexamethyldisilazane |

Relatively Mid-Size Silica

| | | |
|---|---|---|
| AEROSIL RX-50 | 40-50 nm | Hexamethyldisilazane |
| AEROSIL RY-50 | 40-50 nm | Polydimethylsiloxane |

Relatively Large Silica

| | | |
|---|---|---|
| Silica 1 | 80-120 nm | 8 wt % Dimethyldiethoxysilane |
| Silica 2 | 70-100 nm | Hexamethyldisilazane/ |
| | | Polydimethylsiloxane |
| Silica 3 | 80-120 nm | 3 wt % Polydimethylsiloxane |
| Silica 4 | 80-120 nm | 7 wt % Polydimethylsiloxane |
| Silica 5 | 80-120 nm | 4 wt % Hexamethyldisilazane |
| Silica 6 | 80-120 nm | 8 wt % Hexamethyldisilazane |
| Silica 7 | 80-120 nm | 4 wt % Hexamethyldisilazane/ |
| | | 4 wt % Polydimethylsiloxane |

### Example 1

The above particles were added in various combinations to a base toner formulation of a styrene-acrylate based co-polymer having a Mn of 8,000, a Mw of 151,000 and a Tg of 51° C. The toner included a magenta pigment of about 5.1 wt % of PR122, 1.7 wt % of PR184. In addition, a polyethylene wax release agent was present at about 4.8 wt % and a charge control agent was present at about 3.75 wt %.

The base toner particles were blended in a cyclomix blender with 0.2 wt % relatively small silica (AEROSIL R812, available from Evonik Industries) and 0.35 wt % of aluminum oxide (AEROXIDE C805, available from Evonik Industries). A second treatment step included a relatively mid-size silica and a relatively large silica, and 0.5 wt % of titania (FTL-110, available from ISK, USA). The relatively mid-size silica and relatively large silica were added to the toner composition as described below in Table 2.

TABLE 2

| | Relatively | | Relatively | Relatively | |
|---|---|---|---|---|---|
| | Small | Aluminum | Mid-Size | Large | |
| | Silica | Oxide | Silica (wt %) | Silica | Titania |
| Toner ID | (wt %) | (wt %) | (RX-50) | (wt %) | (wt %) |
| Comparative | 0.2 | 0.35 | 2 | 0 | 0.5 |
| Example | | | | | |
| Example 1a | 0.2 | 0.35 | 1.2 | 0.5 | 0.5 |
| Example 1b | 0.2 | 0.35 | 1 | 1 | 0.5 |
| Example 1c | 0.2 | 0.35 | 0.5 | 1.5 | 0.5 |
| Example 1d | 0.2 | 0.35 | 0 | 2 | 0.5 |
| Example 1e | 0.2 | 0.35 | 1.5 | 0.5 | 0.5 |
| Example 1f | 0.2 | 0.35 | 0.5 | 1.5 | 0.5 |
| Example 1g | 0.2 | 0.35 | 0 | 2 | 0.5 |

The above toner compositions were tested for cohesion, Epping charge, mass (m/a), charge for a given mass (Q/M), toner usage (mg/pg) and blotchy defect or mottle. The testing was performed in a printer for approximately 3,000 pages, in a relatively cold and relatively dry environment of 60° F. and 8% relative humidity. Epping charge was measured at ambient lab conditions. The results of these tests are illustrated in Table 3.

TABLE 3

| | | | Mass | Charge | Toner | |
|---|---|---|---|---|---|---|
| | Co- | Epping | (m/a) | (Q/M) | usage | |
| Toner ID | hesion | Charge | (mg/cm²) | (μC/g) | (mg/pg) | Mottle |
| Comparative | 5.0 | −22.8 | 0.62 | −51.1 | 13.1 | Severe |
| Example | | | | | | |
| Example 1a | 4.4 | −20.4 | 0.59 | −49.1 | 13.0 | Moder- |
| | | | | | | ate |
| Example 1b | 4.7 | −16.9 | 0.54 | −45.8 | 11.0 | Light |
| Example 1c | 7.6 | −13.4 | 0.54 | −41.9 | 11.3 | None |
| Example 1d | 13.9 | −9.1 | 0.53 | −36.5 | 13.2 | None |
| Example 1e | 5.7 | −17.6 | 0.53 | −45.2 | 12.9 | Light |
| Example 1f | 7.3 | −11.1 | 0.47 | −39.6 | 13.5 | None |
| Example 1g | 4.8 | −7.1 | 0.51 | −32.2 | 19.3 | None |

In the above, it should be noted that a mottle defect is observed when there is relatively non-uniform development of toner on an imaging substrate, such as paper. The defect arises from non-uniform transfer of toner from an initial imaging member to an imaging substrate, such as paper, resulting in non-uniform print density across the paper. The defect also appears to be lack of toner randomly across the paper, simulating a blotchy appearance. The blotchy appearance would appear to have areas with significantly different print density or L*, or L* greater than 3-4 units in adjacent areas. A rating of “severe” would correspond to the defect present in the entire page, “moderate” would correspond to a defect in more than one-half the page, “light” would correspond to the defect in some areas of the page.

### Example 2

The same base resin was utilized in various formulations including relatively mid-size silica treated with either a silane (hexamethyldisilizane) (AEROSIL RX-50, available from Evonik Degussa Chemical) or silicone oil (polydimethylsiloxane) (AEROSIL RY-50, available from Evonik Degussa Chemical). The base toner particles were blended in a cyclomix blender with relatively small silica (AEROSIL R812, available from Evonik Degussa Chemical) and aluminum oxide (AEROXIDE C805, available from Evonik Degussa Chemical). A second treatment step included the relatively mid-size silica and a relatively large silica. The various toner formulations are outlined in Table 4 and a description of the relatively large silica may be found in Table 1.

TABLE 4

| | | | | | Additional |
|---|---|---|---|---|---|
| | Relatively | Aluminum | Relatively | Relatively | Silica Surface |
| | Small | Oxide | Mid-Size | Large | Treatment |
| Toner ID | Silica (wt %) | (wt %) | Silica (wt %) | Silica (wt %) | (wt %) |
| Comparative | 0.4 | 0.15 | 2 (RY-50) | 0 | |
| Example 2 | | | | | |
| Example 2a | 0.4 | 0.15 | 2 (RY-50) | 0.15 (Silica 1) | Silane |
| Example 2b | 0.4 | 0.15 | 2 (RY-50) | 0.15 (Silica 3) | Silicone Oil |
| Example 2c | 0.4 | 0.15 | 2 (RY-50) | 0.25 (Silica 1) | Silane |
| Example 2d | 0.4 | 0.15 | 2 (RY-50) | 0.25 (Silica 3) | Silicone Oil |
| Example 2e | 0.4 | 0.15 | 2 (RY-50) | 0.5 (Silica 1) | Silane |
| Example 2f | 0.4 | 0.15 | 2 (RY-50) | 0.5 (Silica 3) | Silicone Oil |
| Example 2g | 0.4 | 0.15 | 2 (RY-50) | 1 (Silica 1) | Silane |
| Example 2h | 0.4 | 0.15 | 2 (RY-50) | 1 (Silica 3) | Silicone Oil |
| Example 2i | 0.2 | 0.25 | 2 (RX-50) | 0.25 (Silica 3) | Silicone Oil |
| Example 2j | 0.2 | 0.25 | 2 (RX-50) | 0.5 (Silica 1) | Silane |
| Example 2k | 0.2 | 0.25 | 2 (RX-50) | 0.5 (Silica 3) | Silicone Oil |

The print quality of the above toner formulations were tested in relatively high humidity and relatively high temperature conditions of 78° F. and 80% relative humidity and relatively low humidity and low temperature conditions of 60° F. and 8% relatively humidity. The cohesion, mass (m/a), charge of a given mass, L*, TTU (total toner usage), Ghosting, and Fade to Color were examined. The results for the relatively high humidity and high temperature conditions are given in Table 5 and the results for the relatively low humidity and low temperature conditions are illustrated in Table 6.

TABLE 5

| | | Mass (m/a) | Charge | | | Ghosting | Fade to |
|---|---|---|---|---|---|---|---|
| Toner ID | Cohesion | (mg/cm²) | (Q/M) (μC/g) | L* | TTU | (Halftone) | Color |
| Comparative | 6.8 | 0.54 | −41.2 | 46.2 | 25.2 | 1.0 | −0.37 |
| Example 2 | | | | | | | |
| Example 2a | 5.5 | 0.57 | −40.3 | 48.2 | 26.2 | 0.5 | −0.61 |
| Example 2b | 4.8 | 0.55 | −40.2 | 48.7 | 23.6 | 0.4 | −0.39 |
| Example 2c | 5.4 | 0.54 | −39.4 | 48.9 | 29.0 | 0.6 | −0.68 |
| Example 2d | 4.8 | 0.58 | −39.9 | 53.6 | 22.6 | 0.4 | −0.06 |
| Example 2e | 5.4 | 0.52 | −39.6 | 48.4 | 31.7 | 0.4 | −0.26 |
| Example 2f | 6.2 | 0.57 | −37.7 | 51.7 | 26.0 | 0.4 | −0.52 |
| Example 2g | 5.0 | 0.54 | −33.0 | 51.0 | 31.2 | −2.8 | −1.22 |
| Example 2h | 5.8 | 0.56 | −40.6 | 54.3 | 21.5 | 0.3 | −0.30 |
| Example 2i | 6.6 | 0.53 | −43.0 | 49.0 | 25.8 | 0.6 | −0.86 |
| Example 2j | 5.2 | 0.53 | −40.8 | 49.6 | 29.0 | 0.6 | −0.56 |
| Example 2k | 5.2 | 0.53 | −43.8 | 54.2 | 25.8 | 0.3 | −0.98 |

TABLE 6

| | | Mass (m/a) | Charge | | | Ghosting | Fade to |
|---|---|---|---|---|---|---|---|
| Toner ID | Cohesion | (mg/cm²) | (Q/M) (μC/g) | L* | TTU | (Halftone) | Color |
| Comparative | 6.8 | 0.45 | −51.6 | 53.3 | 8.3 | 1.0 | −0.76 |
| Example 2 | | | | | | | |
| Example 2e | 5.4 | 0.46 | −43.8 | 50.9 | 9.8 | 0.9 | −0.70 |
| Example 2f | 6.2 | 0.47 | −51.4 | 53.2 | 8.7 | −0.4 | 4.79 |
| Example 2g | 5.0 | 0.46 | −39.3 | 49.7 | 10.2 | 0.5 | 0.01 |
| Example 2h | 5.8 | 0.49 | −48.4 | 51.3 | 9.5 | 0.8 | −0.70 |
| Example 2i | 6.6 | 0.51 | −46.0 | 50.6 | 10.5 | 0.6 | −0.36 |
| Example 2j | 5.2 | 0.47 | −43.5 | 50.7 | 10.4 | 0.8 | 0 |
| Example 2k | 5.2 | 0.52 | −45.7 | 50.2 | 10.3 | 0.7 | −0.98 |

### Example 3

In addition to the above, relatively large silica particles including various surface treatments were examined. The base toner composition was utilized in combination with a black pigment (rather than magenta). The base toner particles were blended in a cyclomix blender with relatively small silica (AEROSIL R812, available from Evonik Degussa Chemical) and aluminum oxide (AEROXIDE C805, available from Evonik Degussa Chemical). A second treatment step included the relatively mid-size silica treated with silicone oil (polydimethylsiloxane) (AEROSIL RY-50, available from Evonik Degussa Chemical) and a relatively large silica.

TABLE 7

| | | | Relatively | Relatively | Additional Silica |
|---|---|---|---|---|---|
| | Relatively | Aluminum | Mid-Size Silica | Large | Surface |
| | Small Silica | Oxide | (wt %) | Silica | Treatment |
| Toner ID | (wt %) | (wt %) | (RY-50) | (wt %) | (wt %) |
| Comparative | 0.5 | 0.1 | 2 | 1-Silica 1 | 8-Dimethyl- |
| Example 3 | | | | | diethoxysilane |
| Example 3a | 0.5 | 0.1 | 2 | 1-Silica 4 | 7-Polydimethyl- |
| | | | | | siloxane |
| Example 3b | 0.5 | 0.1 | 2 | 1-Silica 5 | 4-Hexamethyl- |
| | | | | | silizane |
| Example 3c | 0.5 | 0.1 | 2 | 1-Silica 6 | 8-Hexamethyl- |
| | | | | | silizane |
| Example 3d | 0.5 | 0.1 | 2 | 1-Silica 7 | 4-Hexamethyl- |
| | | | | | silizane/4-Poly- |
| | | | | | dimethylsiloxane |
| Example 3e | 0.5 | 0.1 | 1 | 2-Silica 1 | 8-Dimethyl- |
| | | | | | diethoxysilane |
| Example 3f | 0.5 | 0.1 | 1 | 2-Silica 7 | 4-Hexamethyl- |
| | | | | | silizane/4-Poly- |
| | | | | | dimethylsiloxane |
| Example 3g | 0.5 | 0.1 | 1 | 2-Silica 6 | 8-Hexamethyl- |
| | | | | | disilizane |

The above toners were evaluated in a printer at ambient conditions, relatively cool/dry conditions of 60° F. /8% relative humidity and relatively hot/humid conditions of 78° F./80% relative humidity. The results of the testing in these various environmental conditions are illustrated below in Tables 8, 9 and 10, wherein Table 8 includes the ambient conditions, Table 9 includes the relatively cool/dry conditions and Table 10 includes the relatively hot/humid conditions.

TABLE 8
[Ambient]

| | | Mass | Charge | | | | Fade | |
|---|---|---|---|---|---|---|---|---|
| | | (m/a) | (Q/M) | | | | to | |
| Toner ID | Cohesion | (mg/cm²) | (μC/g) | L* | TTU | Ghosting | Color | Mottle |
| Comparative | 8.1 | 0.37 | −29 | 13.05 | 17.5 | 2.35 | −0.35 | Light |
| Example 3 | | | | | | | | |
| Example 3a | 7.3 | 0.37 | −38 | 11.99 | 15.0 | 0.90 | −1.55 | Severe |
| Example 3b | 7.8 | 0.35 | −32 | 12.43 | 18.8 | 1.18 | −1.49 | Moderate |
| Example 3c | 7.4 | 0.36 | −31 | 11.69 | 16.3 | 1.03 | −1.13 | Moderate |
| Example 3d | 7.9 | 0.39 | −35 | 12.19 | 14.3 | 1.23 | −1.64 | Light |
| Example 3e | 8.4 | 0.36 | −27 | 13.89 | 14.2 | 0.88 | −0.74 | Light |
| Example 3f | 9.1 | 0.35 | −40 | 12.23 | 13.0 | 0.78 | −1.51 | Light |
| Example 3g | 8.2 | 0.36 | −30 | 12.02 | 15.1 | 0.95 | −1.34 | Light |

TABLE 9
[Relatively Cool/Dry]

| | | Charge | | | |
|---|---|---|---|---|---|
| | Mass (m/a) | (Q/M) | | | Fade to |
| Toner ID | (mg/cm²) | (μC/g) | TTU | Ghosting | Color |
| Comparative | 0.33 | −58 | 7.3 | 1.5 | 0.97 |
| Example 3 | | | | | |
| Example 3a | 0.33 | −67 | 5.6 | 1.7 | −1.24 |
| Example 3b | 0.34 | −58 | 6.9 | 1.4 | −0.13 |
| Example 3c | 0.37 | −54 | 8.8 | 1.5 | −0.56 |
| Example 3d | 0.36 | −70 | 7.9 | 1.4 | 0.30 |
| Example 3e | 0.36 | −60 | 10.1 | −0.4 | 1.21 |
| Example 3f | 0.38 | −76 | 7.7 | 2.2 | −1.08 |
| Example 3g | 0.38 | −59 | 9.5 | 0.4 | 0.52 |

TABLE 10
[Relatively Hot/Humid]

| | | Charge | | | |
|---|---|---|---|---|---|
| | Mass (m/a) | (Q/M) | | | Fade to |
| Toner ID | (mg/cm²) | (μC/g) | TTU | Ghosting | Color |
| Comparative | 0.35 | −57 | 23.7 | 0.9 | −1.10 |
| Example 3 | | | | | |
| Example 3a | 0.38 | −59 | 24.2 | −0.7 | 0.54 |
| Example 3b | 0.37 | −58 | 22.0 | 1.7 | −0.28 |
| Example 3c | 0.40 | −54 | 25.9 | 1.0 | −1.07 |
| Example 3d | 0.38 | −69 | 21.0 | 1.5 | −0.34 |
| Example 3e | 0.36 | −55 | 19.6 | 0.1 | 2.22 |
| Example 3f | 0.38 | −63 | 17.2 | −0.1 | 0.63 |
| Example 3g | 0.37 | −56 | 19.7 | 0.8 | 0.57 |

Comparison of toner charge, mass at cold/dry or hot/humid environments indicates that the toners are relatively stable in charge and mass irrespective of temperature or humidity. All toners exhibited relatively good transfer properties and in particular, the cold/dry environment indicated no to “light” transfer mottle.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A toner composition, comprising:
toner particles;
silica particles combined with said toner particles having a primary particle size in the range of 30 nm to 60 nm and present in the range of 0.1 to 2.0% wt of the toner composition; and
silica particles combined with said toner particles having a primary particle size in the range of 60 nm to 150 nm and present in the range of 0.1 to 2% by weight of the tone composition.

2. The toner composition of claim 1, wherein said silica particles having a primary particle size in the range of 30 nm to 60 nm are treated with a surface treatment selected from the group consisting of hexamethyldisilazane and polydimethylsiloxane.

3. The toner composition of claim 1, wherein said silica particles having a primary particle size in the range of 60 nm to 150 nm are treated with a surface treatment selected from the group consisting of hexamethyldisilazane, polydimethylsiloxane, dimethyldichlorosilane and combinations thereof.

4. The toner composition of claim 1, further comprising alumina particles present in the range of 0.01% by 1.0% by weight of the toner composition.

5. The toner composition of claim 4, wherein said alumina particles are surface treated with octylsilane.

6. The toner composition of claim 1, further comprising silica particles having a primary particle size in the range of 2 nm to 20 nm present in the range of 0.1% to 0.5% by weight of the toner composition.

7. The toner composition of claim 1, wherein said toner particles comprise styrene-acrylate based copolymer resin.

8. The toner composition of claim 1, wherein said silica particles having a primary particle size in the range of 30 nm to 60 nm are treated with one of hexamethyldisilazane and polydimethylsiloxane and said silica particles having a primary particle size in the range of 60 nm to 150 nm are treated with the other of hexamethyldisilazane and polydimethylsiloxane.

9. The toner composition of claim 1, wherein said silica particles having a primary particle size in the range of 60 nm to 150 nm are present in the range of 0.25% to 1% by weight of the toner composition.

10. The toner composition of claim 1, located in a printer cartridge.

11. A method for providing a toner composition, comprising:
mixing toner particles with silica particles having a primary particle size in the range of 30 nm to 60 nm present in the range of 0.1 to 2.0% wt of the toner composition, and silica particles having a primary particle size in the range of 60 nm to 150 nm present in the range of 0.1 to 2% by weight of the toner composition.

12. The method of claim 11, wherein said silica particles having a primary particle size in the range of 30 nm to 60 nm are treated with a surface treatment selected from the group consisting of hexamethyldisilazane and polydimethylsiloxane.

13. The method of claim 11, wherein said silica particles having a primary particle size in the range of 60 nm to 150 nm are treated with a surface treatment selected from the group consisting of hexamethyldisilazane, polydimethylsiloxane, dimethyldichlorosilane and combinations thereof.

14. The method of claim 11, further comprising alumina particles present in the range of 0.1% by 1.0% by weight of the toner composition.

15. The method of claim 11, wherein said alumina particles are surface treated with octylsilane.

16. The method of claim 11, further comprising silica particles having a primary particle size in the range of 2 nm to 20 nm present in the range of 0.1% to 0.5% by weight of the toner composition.

17. The method of claim 11, wherein said toner particles comprise styrene-acrylate based copolymer resin.

18. The method of claim 11, wherein said silica particles having a primary particle size in the range of 30 nm to 60 nm are treated with one of hexamethyldisilazane and polydimethylsiloxane and said silica particles having a primary particle size in the range of 60 nm to 150 nm are treated with the other of hexamethyldisilazane and polydimethylsiloxane.

19. The method of claim 11, wherein said silica particles having a primary particle size in the range of 60 nm to 150 nm are present in the range of 0.25% to 1% by weight of the toner composition.

20. The method of claim 11, including locating said toner composition in a printer cartridge
